(19) United States
(12) Patent Application Publication
(10) Pub. No.: US 2015/0213160 A1
(43) Pub. Date: Jul. 30, 2015

(54) LOCALLY ADAPTIVE SPATIALLY EXPLICIT POPULATION PROJECTION SYSTEM

(71) Applicant: UT-Battelle, LLC, Oak Ridge, TN (US)

(72) Inventors: Eddie A. Bright, Oak Ridge, TN (US); Amy N. Rose, Oak Ridge, TN (US); Jacob J. McKee, Oak Ridge, TN (US); Timmy N. Huynh, Oak Ridge, TN (US)

(73) Assignee: UT-Battelle, LLC, Oak Ridge, TN (US)

(21) Appl. No.: 14/163,372

(22) Filed: Jan. 24, 2014

(51) Int. Cl. G06F 17/50; G06F 17/18

(52) U.S. Cl. CPC G06F 17/5009; G06F 17/18

(57) ABSTRACT

A locally adaptive spatial system renders spatially explicit population projections. The system identifies selected land areas that are excluded from future development. It identifies potential growth areas that identify land areas that are projected to gain populations by modeling land variables. The system classifies the population projections as infill or sprawl based on the current local urbanization index and identifies potential loss surfaces that identify land areas that are projected to lose populations. The system spatially allocates population changes at a county level based on the infill, sprawl, and population loss designations.

### STATEMENT REGARDING FEDERALLY SPONSORED RESEARCH AND DEVELOPMENT

The invention was made with United States government support under Contract No. DE-AC05-00OR22725 awarded by the United States Department of Energy. The United States government has certain rights in the invention.

### BACKGROUND

1. Technical Field

This disclosure relates to population projections and more specifically to projecting and mapping population changes.

2. Related Art

Disaster readiness and emergency preparedness may mitigate the effects of climate change and national security challenges. These issues can affect large scale populations. Thus, there are benefits in knowing how populated areas may change. Today, populations are measured by censuses. With limited data associated with these measurements, it is difficult to predict how populations will change.

Many environmental models do not predict changes to local areas or changes to the distribution of populations. The systems lack adaptive techniques that predict local population dynamics and their spatial distributions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a logic diagram modeling a spatially explicit projected population.

FIG. 2 shows a visual representation of the correlation between urban land area and urban population of counties in the contiguous U.S.

FIG. 3 shows a visual representation of a population of San Francisco in 2010 and the population projections for the year 2030 and 2050.

FIG. 4 shows a visual representation of the population of San Francisco in 2010 and the population projections for the year 2050 in two dimensions.

FIG. 5 shows a visual representation of a population of Washington DC in 2010 and the population projections for the year 2050.

FIG. 6 shows a visual representation of a population of the United States in 2010.

FIG. 7 shows a visual representation of the population projection of the United States in 2030.

FIG. 8 shows a visual representation of the population projection of the United States in 2050.

### DETAILED DESCRIPTION OF THE PREFERRED EMBODIMENTS

Locally adaptive spatial systems forecast population changes and spatial distributions of these projections in two, three, or four (e.g., space-time continuum) dimensional space. The systems process theoretical and empirical variables or constraints to estimate change and predict spatial distributions of population forecasts of the future. The systems generate locally adaptive models that render graphical representations that display local, national, and very large scale distributions. The distributions reflect the processing of spatially varying dynamics. The projections may predict population vulnerabilities, identify areas for new physical construction, future spheres of influence, potential consumer bases, and may be used for local and/or regional planning, suitability modeling, consequence assessment, mitigation planning and implementation.

Applying a multivariable dasymetric modeling approach, some locally adaptive spatial systems identify potential growth surfaces for small and/or large contiguous areas. For the contiguous U.S., for example, population projections at the county-level (e.g., an administrative subdivision in the U.S.) may use census's projections as benchmarks. To account for spatial allocation rates, projected new population in designated geographical regions or jurisdictions (e.g., such as counties) are designated as “infill” (new population growth in existing urban areas) or “sprawl” (new population growth and/or development in areas outside existing urban areas). The designations may be based on a local urbanization index derived from projected patterns of urban population and urban land area percentages on regional or jurisdictional levels. The locally adaptive spatial systems generate separate development potential coefficient surfaces for each urban and non-urban area that collectively comprise the contiguous areas. Input variables include land cover, slope, distances to larger cities, and a moving average of current population in some locally adaptive spatial systems. Some systems also process ancillary data too (like LiDAR for buildings, school enrollment figures, workforce numbers, etc.). The resulting surface area projections determine which areas have a greater likelihood for future population change, with “infill” or “sprawl” populations allocated accordingly. In some systems, gross urban density is programmed to remain constant as the current time to limit “sprawl” growth to a county-specific area.

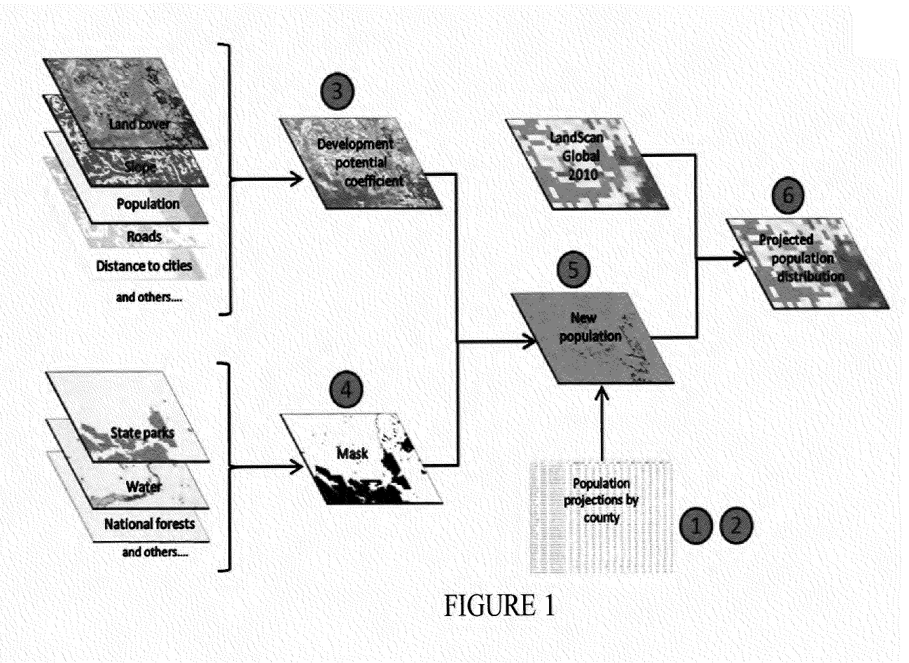

To account for each of the local spatial allocation rates, such as the contiguous U.S. for example, some locally adaptive spatial systems process population projections at the county level. Other locally adaptive spatial systems not only process population projections at the county level but also project populations at the county level (as shown in #1 and #2 of FIG. 1) and generate spatial details at the county level. The systems may use a cohort-component model to project population counts for each county, as expressed in equation 1:

Pₓ₊ₙ=Pₓ+(B_{x,x+n}−D_{x,x+n})+(IM_{x,x+n}−OM_{x,x+n}) (equation 1)

where P=population, B=births, D=deaths, IM/OM=in/out-migration, x=current time, and x+n=future time. In this exemplary model, future populations are projected by the sum of the current population and births, less deaths, plus net migration. The counts for births, deaths, and migration are the number of each that occurred in an x to x+n interval. Age and sex-specific numbers and rates for births and deaths may be processed for the birth and death variables.

Some locally adaptive spatial systems mine data from remote sources such as census data, the National Center for Health Statistics (NCHS), and the Internal Revenue Service (IRS). The base year population count for the year 2010, for example, may be based on the U.S. Census 2010 data set. The data for the population count for each county may be divided by five-year cohorts from ages 0-4, 5-9, 10-14, . . . 85-89, with ages 90+ grouped together. The birth and death data may be mined from a NCHS data warehouse. The number of live births may be provided by five-year age cohorts of the mother from ages 10-14, 15-19, 20-24, . . . to 50-54. Death data may be used for each sex for each five-year cohort groupings up to the age group 90+. To increase predictability, death data for predetermined periods may be grouped together. Some systems divide the deaths by five-year age cohort groupings from age 5-9, 10-14, 15-19, . . . to 95-99 with the last age group over 100 years old grouped together and those less than 1 years of age separated from the cohort grouped in to the 1-4 category. To match the U.S. census population age cohorts, age cohorts that fall within the age groupings 90-94, 95-99, and over 100 years old are summed together for ages 90+ and those less than 1 year of age and cohorts falling into the 1-4 category being combined to form age cohort 0-4.

Migration data may be mined from many sources such as the World Bank or an IRS data warehouse, for example. When the IRS data warehouse is mined, data may be based on year-to-year address change data minded from filed tax returns. The numbers of inflow, outflow, and non-migrants for each county may be mined as the number of tax returns (e.g., the approximate number of households) filed and the number of exemptions (i.e., approximate number of individuals) claimed.

Some locally adaptive spatial systems combine birth data from NCHS with population count data from census data to render age-specific fertility rates (ASFRs). The ASFR described in equation 2 provides the rate at which babies are born to women of specific age cohorts and may differentiate the varying fertility rates of women in different ages.

$${ASFR}_{x , x + n} = \frac{{B}_{x , x + n}}{{P}_{{F}_{x , x + n}}} \qquad ( equation 2 )$$

In equation 2, ASFR=age-specific fertility rate, x=the starting year of an age cohort, n=the length of the age cohort, B=number of births, P=population count, and F=the female population. When data is unavailable, the locally adaptive spatial systems may follow and execute programmable projection rules (“rule”) that may be part of a knowledge base of an expert system. For example, if birth data is only available for counties with a population of 100,000 or more; by rule some locally adaptive spatial systems may aggregate the number of births measured for each of the small counties in each state or territory to render an aggregated value B. When projecting population for smaller counties, the age-specific fertility rates are programmed to be the same for counties with less than 100,000 people within each state by exemplary rule.

To project mortality, death data minded from the NCHS data warehouse may be partially combined with population count data from the census data to derive age-specific survivability rates (ASSRs) for each sex. The ASSR model provides the rate at which people within one age interval survive to the next age interval. For example, the ASSR for most ages in this model will be upwards of about 99%, while the ASSR for new infants will tend to be slightly lower and the ASSR for the older ages will tend to drop off steadily as age increases. The age-specific survivability rates may be expressed by equation 3

$${ASSR}_{x , x + n} = \frac{{L}_{x + n}}{{L}_{x}} \qquad ( equation 3 )$$

where ASSR_{x,x+n} is the probability of a member of the age cohort surviving from time x to x+n, Lₓ₊ₙ is the number of persons alive at end of period x+n, Lₓ is the number of persons alive at beginning of age interval x, n=the length of the time period (in units of years). In this model, the formula may be rearranged as equation 4.

$${ASSR}_{x , x + n} = 1 - \frac{{D}_{x + n}}{{L}_{x}} \qquad ( equation 4 )$$

where Dₓ₊ₙ is the number of deaths within each age cohort. In addition to the count of deaths, some NCHS data has population counts (of the population) for each age cohort up through ages 80-84. From age 85 onward, census data may be used. For small counties that may not have had deaths in some age cohorts intervals, the survivability rate may be established by rule, such as a rule that establishes the survivability rate to be the average of the adjacent age cohort above and below the data set. Another rule may establish a zero survivability rate if there is no data in the oldest age cohort.

Migration data from a data warehouse such as from an IRS data warehouse may be processed to derive a migration rate. The data may identify total inflow migration, outflow migration, and non-migration by county for both U.S. and foreigners who filed tax returns. The migration rate may reflect the net change in migration over a specific time period. The migration rate by county may be established by equation 5

$$MR = \frac{IF - OF}{NM + OF} \qquad ( equation 5 )$$

where MR is the migration rate, IF is the total number of inflow migrants, OF is the total number of outflow migrants, and NM is the total number of non-migrants. IF−OF represents the net migration number of people and NM+OF represents the number of people who lived in the county at the beginning of the time interval. If age-specific migration rates are not available, a rule may establish that the same migration rate may be used for all age and sex groups.

To calculate the population change, some locally adaptive spatial systems may apply a rule that that people will be born, die, and move at the same rates as in the current time the projections are made. Projections may be calculated for every five years, such as from 2010 to 2050. An exemplary system's projections may be based on 2010 data, with the same programmable steps repeated for each five-year increment until a desired year such as up to the year 2050. In this example, the base year population from the Census 2010 may be designated the 2010 population. Because the age cohorts are in five-year intervals, the system may project population changes for every five years. The algorithms of projecting the youngest, oldest, and middle cohorts may differ slightly. To project the middle age cohorts, the exemplary system executes equation 6.

For x={0, 5, 10, . . . , 80} at time t,

Pₜ₊ₙ_{_{x+n,x+2n}}=(Pₜ_{_{x,x+n}}×MR)×ASSR_{x,x+n} (equation 6)

where x represents the beginning age of each age cohort at time t, Pₜ_{_{x,x+n}} represents the population count of one of the middle age cohorts at time t, Pₜ₊ₙ_{_{x+n,x+2n}} represents the population count of that same cohort aged to time t+n, MR=migration rate, and ASSR is the age-specific survivability rate. To project the age 5-9 cohort for 2015, for example, the MR may be applied to the age 0-4 cohort for 2010 and the result may then be multiplied by the ASSR. This algorithm may be repeated for all of the age cohorts except the eldest age cohort interval. In the case of the eldest cohort interval, some locally adaptive spatial systems calculate the population change by equation 7.

For x={85} at time t,

Pₜ₊ₙ_{₉₀₊}=[(P₈₅₋₈₉×MR)×ASSR₈₅₋₈₉]+[(Pₜ_{₉₀₊}×MR)×ASSR₉₀₊] (equation 7)

where Pₜ_{₉₀₊} represents the eldest age cohort at time t, Pₜ_{₈₅₋₈₉} represents the second-eldest age cohort at time t that will age into the eldest age cohort at time t+n, and Pₜ₊ₙ_{₉₀₊} represents the eldest age cohort at time t+n. To project the age 90+ cohort for 2015, some locally adaptive spatial systems apply the same algorithm for the middle age cohorts (e.g., apply the MR and ASSR model for the age cohort adjacently younger in 2010) as well as adding the population that migrated and survived from the age 90+ cohort from 2010. To project new births at time t+n, some locally adaptive spatial systems may execute equation 8.

For x={0} at time t+n,

$${P}_{t + {n}_{0 - 4}} = 5 \times {\sum }_{x = 10}^{50} [ {ASFR}_{x , x + n} \times {P}_{{F}_{{t}_{x , x + n}}} ] , \qquad ( equation 8 )$$

where x=(10, 15, 20, . . . , 50) and refers to the age of the female population at time t
   where ASFR=age-specific fertility rate, P_{F}=the female population count of a given age cohort, and Pₜ₊ₙ_{₀₋₄} represents the number of new people at time t+n, the factor “5” represents the range in the cohort interval and x refers to the age of just the female population at time t. To determine the age 0-4 cohort for 2015, for example, the 2010 population counts of females from age cohorts 10-14 through 50-54 may be multiplied by their respective ASFRs and summed and multiplied by five. However, since this count is the number of total new people (births) and not sex-specific, some locally adaptive spatial systems distribute this number for each projection year proportionally among males and females to match the age 0-4 cohort's sex ratio in 2010. The locally adaptive spatial systems may repeat this process when predicting population growth through births for each five-year increment out to a desired year such as 2050 in this example. The county totals may be aggregated to a total national population for 2030 and 2050 and adjusted proportionately to match the U.S. Census's official population projections for those years.

To distribute future projected populations, several variables may be processed to create a “potential growth” surface and several variables may be used to identify selected areas to exclude from future development as shown in #3 of FIG. 1. By rule, some locally adaptive spatial systems exclude land from development because federal, state, and/or local policies as shown in #4 of FIG. 1. By rule, for example, open space within the existing urban environment, whether it is public green space, parks, or cemeteries, from a quantitative standpoint may be highly desirable and suitable land for development; however, because the areas are frequently subject to planning controls some locally adaptive spatial systems designate these areas as being unlikely to be developed. Excluded areas may be designated by processing data warehouses that retain data from Homeland Security Infrastructure Program (HSIP) Gold Dataset 2012 and NLCD 2006 that may identify: airport boundaries, federal defense sites (military installations, munitions ranges, forts, etc.), national parks, national monuments, national forests, wildlife refuges, state/county/city parks, golf courses, cemeteries, water, perennial ice, and wetlands, etc. High-intensity urban areas may also be excluded by some locally adaptive spatial systems because the systems concluded that the areas had reached a maximum capacity and had therefore exhausted all potential resources for future growth.

Slope and land cover are among some the variables processed by some locally adaptive spatial systems to create a “potential growth” surface as shown in #3 of FIG. 1. The systems mined 1 arc-second Digital Terrain Elevation Data 2 data from a National Geospatial Intelligence Agency data warehouse and extracted slope values identified in census data such as the 2010 U.S. Census Urban Areas, for example. Some locally adaptive spatial systems calculated the percentage represented by each slope value and weighted each value with respect to the proportion it represented. Slope was processed in this exemplary model to prevent development from occurring in impractical locations. According to an exemplary premise of the model, slope may play a major role in determining the development potential of an individual site. While flat and gently-sloped parcels may be more easily and inexpensively developed, the difficulty and expense of developing a designated area may correspondingly increase with slope that exceeds a predetermined value that may change with each county. Along with slope, some locally adaptive spatial systems executed a land cover weighting scheme as shown in #3 of FIG. 1, using National Urban Change Indicator (NUCI) data and data mined from a remote land cover database warehouse such as the National Land Cover Database (NLCD) 1992. To determine which land cover classes had the highest probability of becoming developed, some locally adaptive spatial systems executed a county land cover change analysis using NLCD 1992 as a baseline (‘from class’) and NUCI data as the resulting land cover class (‘to class’). The prior land cover class of all change pixels was recorded and stored using NLCD 1992. The number of urban change cells was then normalized to account for the total number of cells represented by each land cover class per county. The land cover classes were then weighted based on their probability of urban change.

To account for the suitability aspect, some locally adaptive spatial systems executed different knowledge bases of the expert system that accounted for the social potential of an area to become developed. The different facts and rules may include gravity-based variables such as population and infrastructure amenities. Under the models rule that population attracts additional population, current population can act as a proxy for existing amenities and/or represent some underlying attractant which may not be quantifiable, known, or fully understood. To reflect this rule, locally adaptive spatial systems executed a moving average of the current population. Specifically, for each cell, the per-cell average of the population in all cells within predetermined area, such as about a 4-mile radius. The cells were then ranked and weighted based on their current population values.

City populations may also be processed by some locally adaptive spatial systems to create a “potential growth” surface as shown in #3 of FIG. 1. From remote HSIP data warehouses, some locally adaptive spatial systems identified and selected cities that had population that fell within in cell ranges, such as ≧30,000, ≧50,000, and ≧100,000, for example. For each cell, the distance may be calculated to the nearest city in each of the three city classifications. These distances were then classified into twelve categories at set percentages (specifically, every 10 percentage points from 0-90 as well as 95 and 99 percent) of distances for all non-zero trips as captured in a travel database such as the National Household Travel Survey (NHTS) 2009, for example. By this example, the 30 percent threshold corresponds to a trip distance value of 2 miles, meaning that at least 30 percent of non-zero trips in the NHTS dataset are 2 miles in length or shorter. Using this process, cities with a larger population were also encompassed in the cities with a smaller population threshold. To account for the overlaps, the weights given to the larger cities were increasingly smaller.

Interstate exits, available in the HSIP dataset may also be processed by some locally adaptive spatial systems to create a “potential growth” surface. Like the city variables, the locally adaptive spatial systems calculated the distance from each cell to the nearest highway exit and then classified the exits as it did when processing the distance to cities. These variables identified population preferences to specific areas.

Roads were also processed by some locally adaptive spatial systems as a variable for “potential growth” because they offered an avenue for settlement, development, and access to resources as shown in #4 of FIG. 1. Mining a remote geographic dataset such as Navteq 2011 datasets stored in a warehouse, roads were buffered by 150 meters on either side of the road and broken down into five concentric buffers, each with a width of thirty meters. The system applied weights to the roadway buffers that were inversely related to the distance to the roadway. The system based the structure of the road weights on the likelihood of future growth being more likely to occur in a linear fashion along existing roads due to accessibility and visibility as opposed to areas which may be further from transportation infrastructure. Areas further from the roadside may eventually be developed according to this model, but most likely would not occur until readily accessible road frontage parcels are no longer available. This weighting scheme was applied by some locally adaptive spatial systems to model sprawl, which may be characterized by commercial strip development and low-density development along roadways outside cities and suburbs.

City limits and proximity to oceans (and/or lakes) were also processed by some locally adaptive spatial systems from an HSIP dataset. The inclusion of city limits reflected the model's premise that such areas were more likely to become developed than if they were outside city limits. Similarly, the inclusion of water reflected the medium's attraction to urban development.

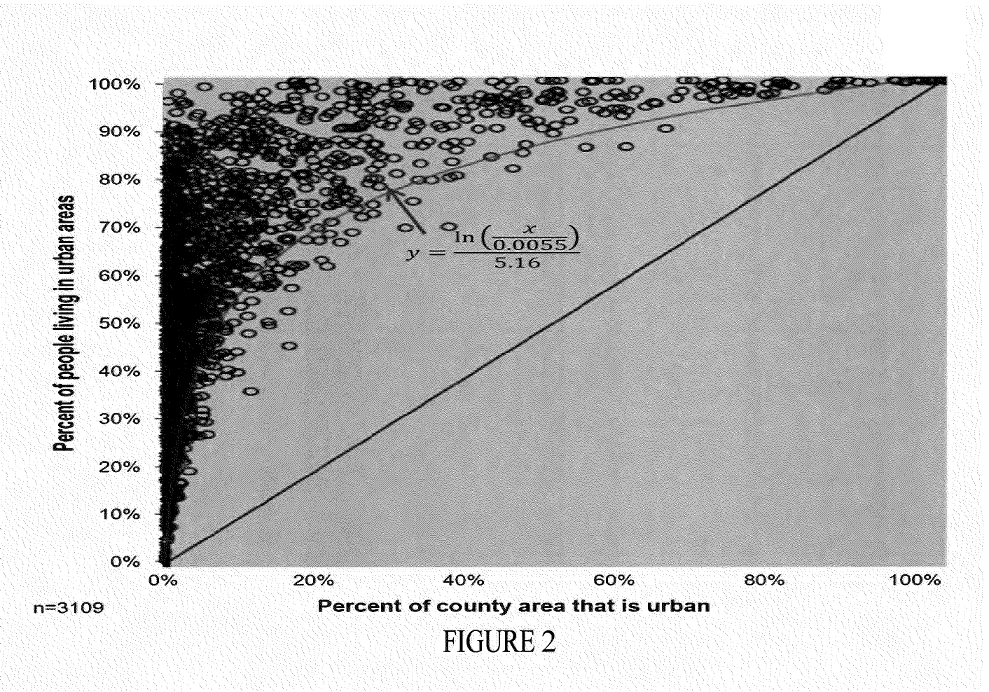

To calculate the different rates of spatial allocation, some locally adaptive spatial systems classified projected new population as either “infill” or “sprawl” based on current patterns of urban population percentages and urban land area percentages per county. The term “infill” is used as an inconclusive term combining “infill development” and “urban redevelopment.” The model executed by the locally adaptive spatial systems calculates a county-specific infill rate based on current population trends (#5 of FIG. 1). As shown in FIG. 2, the percentage of people living in a county's census-defined urban areas is correlated with the percentage of that county's area that is urban.

To determine what percentage of new population would be distributed as infill, some locally adaptive spatial systems calculated a “best-fit” logarithmic line set at the threshold of the county data points that captures about 95% of the counties (where n=2954). To model the infill rate, the system executes equation 9.

$$y = \frac{ln ( \frac{x}{0.0055} )}{5.16} \qquad ( equation 9 )$$

where x=the percentage of the county area that is urban and y=the infill rate. The infill rate is then normalized to predetermined thresholds. For example, a county having over about 95.79% urban land may be normalized as having 100% of new population allocated to existing urban areas (100% infill) and counties' having less than 0.55% urban land may be normalized as having 0% of the new population living in a previously established urban area (0% infill).

To constrain sprawl growth, some locally adaptive spatial systems established population growth for each county would occur at the current density of people per unit of urban area. The system derived a Gross Urban Density (GUD) by mining the urban population per county and dividing it by census data such as census data designated as an urban area. The resulting quotient is a ratio of people per urban cell per county. To distribute the projected population for the targeted years, the systems may first calculate how many cells are needed to accommodate the projected growth. Some systems divides the projected population growth for each county by the county's GUD, resulting in the number of cells per county that were needed to accommodate new population. For counties that do not contain an urban area defined by a census, the system may average population distribution data sources. For example, some locally adaptive spatial systems averaged LandScan™ USA 2010 Night and Day data and calculated the number of cells occupied by population. The population for each non-urban county was divided by the number of occupied cells, rendering a ratio of the average number of people per cell. Population growth for these counties was divided by this ratio, resulting in the number of cells needed to accommodate growth in counties with no urban area.

To create the “potential growth” surface of individual cumulative cell weights, the systems sums the grids and aggregated the grid to 3 arc-second and separated the coefficient grid into urban and non-urban areas. Infill population is distributed to existing urban areas, while sprawl population is distributed to non-urban areas, yet, is constrained to the number of cells determined by the county's GUD. The infill and sprawl coefficient surfaces were individually combined and weighted with their respective population of the total projected county growth to develop a county level likelihood coefficient executed by equation 10 and shown in #5 of FIG. 1.

$${PC}_{County} = \frac{Total {Population}_{County}}{{Σ}_{1}^{n} WCell i , j} \qquad ( equation 10 )$$

In equation 10 PC is the Population Coefficient and N is the Number of cells describing the area. The total population for that area, whether ‘infill’ or ‘sprawl’ was allocated to each cell weighted by the calculated likelihood (population coefficient) of being populated is rendered by equation 11.

Population_{Cell i;j}=PC_{County}×W_{Cell i,j} (equation 11)

For the counties that were projected to lose population (e.g., potential loss surfaces), some locally adaptive spatial systems processed the population total for each county and used global population data such as data available through LandScan™ USA Night and Day average population distribution data as the coefficient grid. The locally adaptive spatial systems executed the same models and formulas to calculate a likelihood loss coefficient and distribute the population. Redistributing the total county population based on the current distribution prorated the projected population loss. Once the population had been distributed for each scenario, the ‘infill’, ‘sprawl’, and ‘population loss’ grids were mosaicked together to create a continuous surface of population growth/decline. The locally adaptive spatial systems then aggregated the grid to a 30 arc second resolution and added it to global population distribution data such as the LandScan Global™ data stored in a warehouse as shown in #6 of FIG. 1, resulting in the projected population distribution for the target year. In turn, the locally adaptive spatial systems may repeat this process to achieve the projected population distribution for other designated years or a range of years.

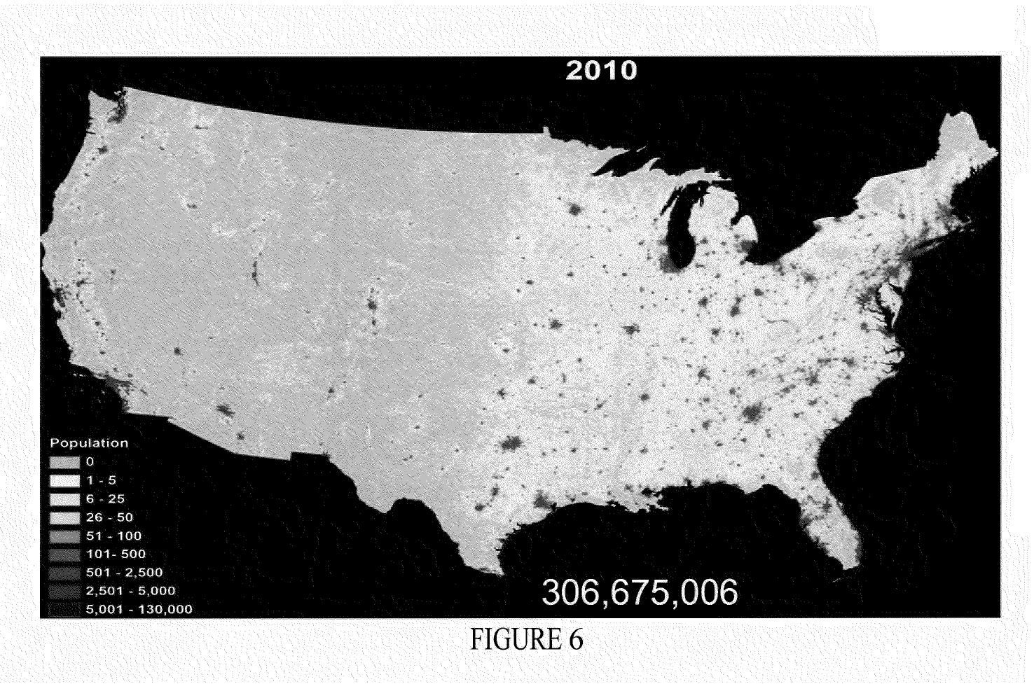

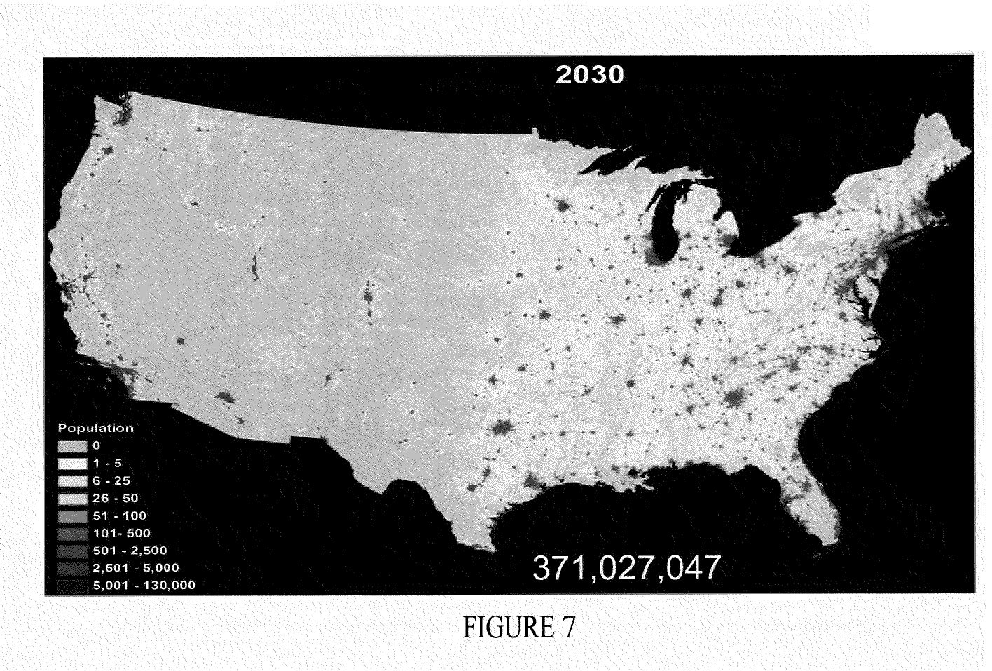

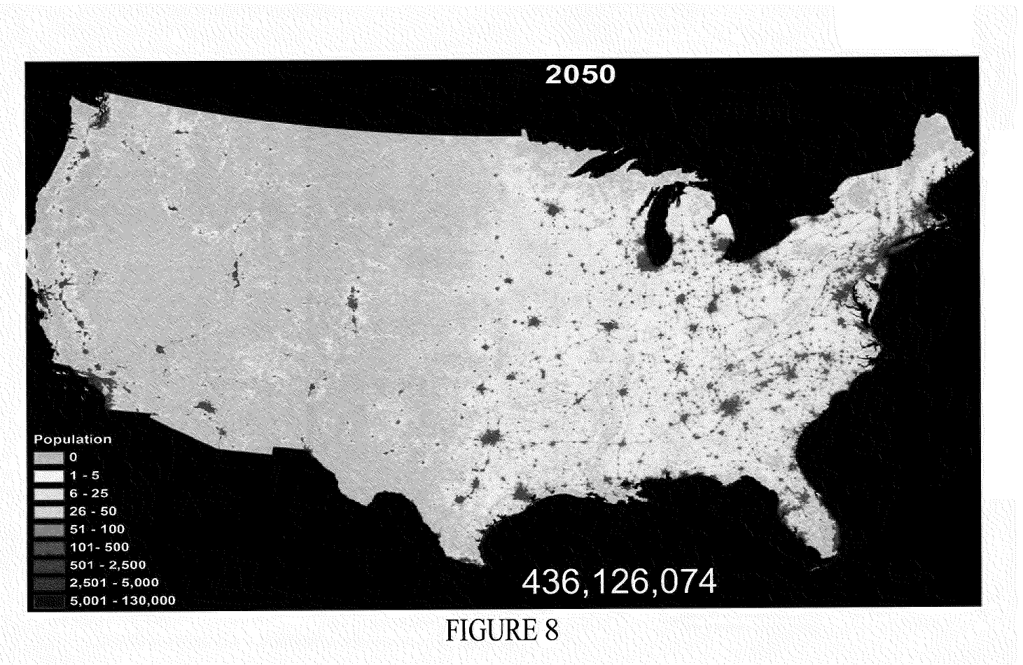

An exemplary application of the locally adaptive spatial system processed global population distribution data generated by LandScan Global™ 2010 as a baseline, for spatially allocating population change in the years 2030 and 2050 for the contiguous US. For 2010, the population for the contiguous US was 306,675,006 (as shown in FIG. 6), with projected populations of 371,027,047 for 2030 (as shown in FIGS. 7) and 436,126,074 for 2050 (as shown in FIG. 8).

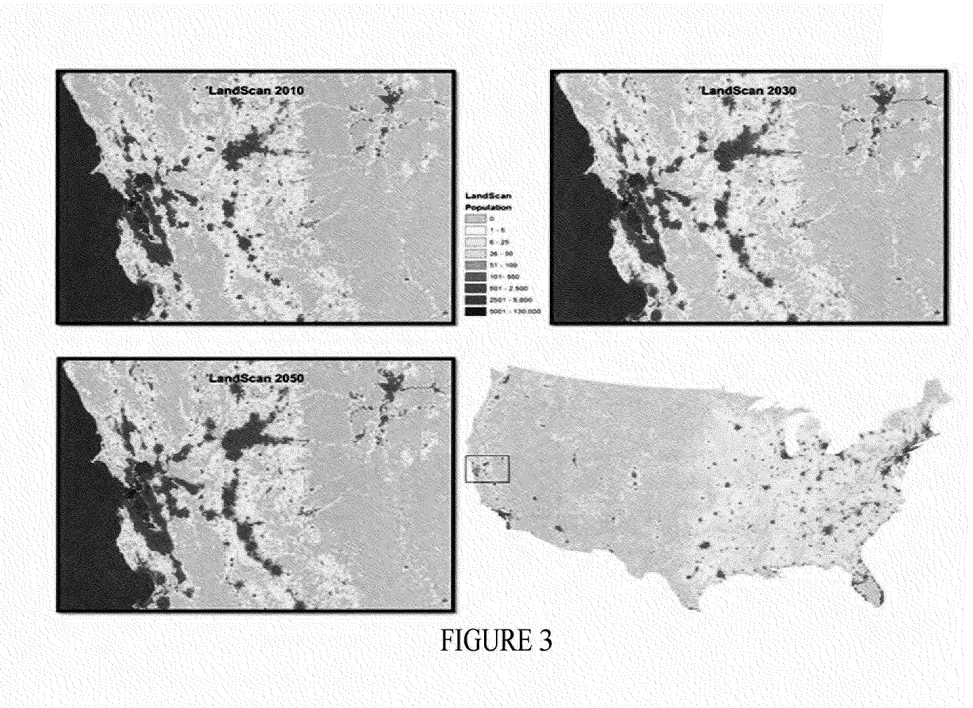

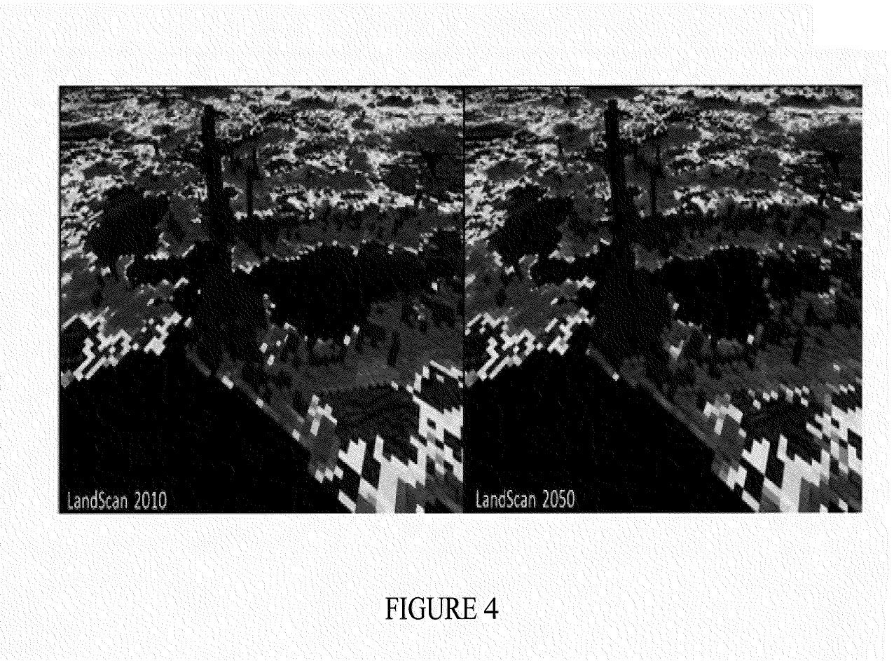

Based upon the spatial data and the socioeconomic and cultural understanding of the contiguous US, the predicted ambient population distribution for the continuous US is shown for 2030 in FIG. 3, with the projected population of the San Francisco area for 2030 and 2050. On a smaller scale, FIG. 4 is a three dimensional visualization of San Francisco

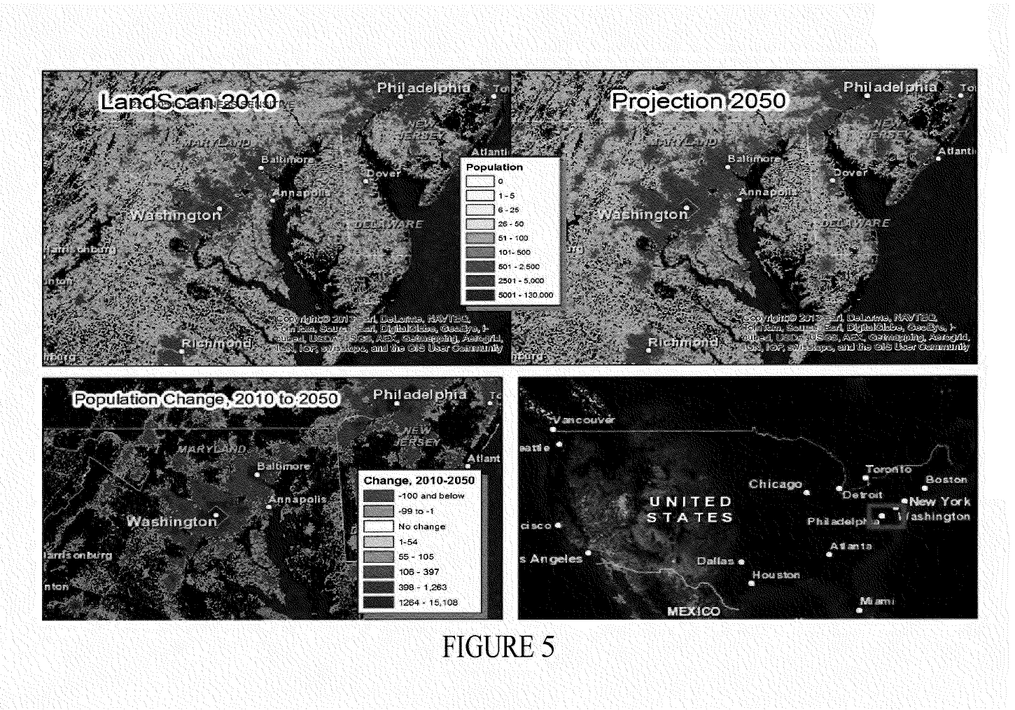

Bay area viewed from the South-west and FIG. 5 is the projected population of the Washington DC area from 2010 to 2050 The ambient nature of the resulting distribution integrates both diurnal movements and collective travel habits into a single measure.

The systems, processes, and models described above may be implemented in many other ways in many different combinations. In some alternative systems, alternative data sources are processed and alternative knowledge bases and rules are applied. For example, some locally adaptive spatial systems do not assume that population changes will be constant and thus these systems are programmed to account for other variations too. Some alternative locally adaptive spatial systems interface expert systems, analytical rules, and knowledge bases that model and project land cover changes, changes to urban and non-urban areas at the county level, same day migration and population loss patterns.

The locally adaptive spatial systems incorporate a range of theoretical and empirical growth constraints to simulate population growth and predict the spatial distribution of population for the years to come. Some modeling process uses a cohort-component model to project population counts for each country and primary geospatial input or ancillary datasets, including land cover, roads, slope, and divisions between non-urban and urban areas; all of which may be indicators of future population distribution. Based upon the spatial data and the socioeconomic and cultural understanding of an area, land area cells are preferentially weighted for the possible changes. Within each county, the population distribution model calculates a “likelihood” coefficient for each cell and multiples the coefficients to the population projections, which forecast totals for appropriate areas. The projected population for that area is then allocated. The resultant population may be designated an ambient or average population count. The locally adaptive spatial systems may interface other population distribution models and spatial modeling approach including the LandScan™ modeling process. The locally adaptive spatial systems render large-scale, national level population distributions which can serve as an early identifier of spatially vulnerable populations, thus increasing mitigation preparation and response time in crisis situations.

The systems and processes described above may be implemented in many different combinations of hardware, software or both hardware and software and may be used to predict and visually render high resolution spatial images of population projections. All or parts of the system may be executed through one or more controllers, one or more microprocessors (CPUs), one or more signal processors (SPU), one or more graphics processors (GPUs), one or more application specific integrated circuit (ASIC), one or more programmable media or any and all combinations of such hardware. All or part of the systems and processes described above may be implemented as instructions for execution by a microcontroller that comprises electronics including input/output interfaces, a microprocessor, and an up-dateable memory comprising at least a random access memory which is capable of being updated via an electronic medium and which is capable of storing updated information, processors (e.g., CPUs, SPUs, and/or GPUs), controller, or other processing devices and may be displayed through a display driver in communication with a remote or local display, or stored and accessible from a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, includes a specifically programmed storage medium and computer readable instructions stored on that medium, which when executed, cause the device to perform the specially programmed operations according to the descriptions above.

The modeling systems may project populations and render spatial distribution images that may be shared and/or processed by multiple system components, such as among multiple processors and memories (e.g., non-transient media), including multiple distributed processing systems. Parameters, databases, pre-generated models and data structures used to evaluate and forecast population changes may be separately stored and executed by the processors. It may be incorporated into a single memory block or a local or remote database warehouse, may be logically and/or physically organized in many different ways, and may be implemented in many ways. The programming executed by the modeling systems may be parts (e.g., subroutines) of a single program, separate programs, application program or programs distributed across several memories and processor cores and/or processing nodes, or implemented in many different ways, such as in a library or a shared library accessed through a client server architecture across a private network or publicly accessible distributed network like the Internet. The library may store projection and the spatial data and imagery software code that performs the system processing and rendering described herein. While various embodiments have been described, it will be apparent to those of ordinary skill in the art that many more embodiments and implementations are possible.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount. When devices are responsive to commands events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A locally adaptive spatial system that renders spatially explicit population projections comprising a non-transitory media storing programming that:
identify selected land areas that are excluded from future development and population growth;
identify historical local land cover development trends;
identify potential growth surfaces that identify second land areas that are projected to gain populations by modeling land variables;
classify the population projections as infill or sprawl based on a local urbanization index;
identify potential loss surfaces that identify third land areas that are projected to lose populations; and
spatially allocates the population changes at a county level based on the infill, sprawl, and population loss designations.

2. The locally adaptive spatial system of claim 1 where selected land areas that are excluded from future development are based on cultural variables.

3. The locally adaptive spatial system of claim 1 where the spatially explicit development change likelihood is based on historical local land cover change trends.

4. The locally adaptive spatial system of claim 1 where the land variable comprises a plurality of slopes of the land area.

5. The locally adaptive spatial system of claim 1 where the land variable comprises a plurality of gravity based model variables.

6. The locally adaptive spatial system of claim 1 where the land variable comprises an average population of the land area.

7. The locally adaptive spatial system of claim 1 where the land variable comprises a plurality of locations of road exits.

8. The locally adaptive spatial system of claim 1 where the land variable comprises a plurality of locations of roads.

9. The locally adaptive spatial system of claim 1 where the land variable comprises a plurality of locations of oceans and lakes.

10. The locally adaptive spatial system of claim 1 where the land variable comprises a plurality of slopes of the second land area, a plurality of gravity-based variables, populations of the potential growth surfaces, a plurality of locations of roads and road exits, and a plurality of locations of oceans and lakes.

11. The locally adaptive spatial system of claim 1 where the classification of the population projections as infill is based on a current local urbanization index.

12. The locally adaptive spatial system of claim 1 where the classification of the population projections as sprawl is based on a current local urbanization index.

13. The locally adaptive spatial system of claim 1 where the potential growth surface comprise a surface of individual cell weights.

14. The locally adaptive spatial system of claim 1 where the population changes is based on a projection rendered by a cohort-component model.

15. A locally adaptive spatial system that renders spatially explicit population projections, comprising:
a processor;
a memory; and
a program, where the program is stored in the memory and configured to be executed by the processor, the program including instructions for:
rendering a cohort-component model that projects population changes at a county level;
identifying selected land areas at the county level that are excluded from future development;
identifying potential growth surfaces that identify second land areas at the county level that are projected to gain populations by modeling land variables;
classifying the population projections as infill or sprawl based on the current local urbanization index;
identifying potential loss surfaces that identify third land areas that are projected to lose populations; and
spatially allocating the population changes at a county level based on the infill, sprawl, and population loss designations.

16. The locally adaptive spatial system of claim 15 where the land variable comprises a plurality of slopes of the second land area, a plurality of gravity-based variables, a plurality of populations of the potential growth surfaces, a plurality of locations of roads and road exits, and a plurality of locations of oceans and lakes.

17. The locally adaptive spatial system of claim 15 where the classifying of the population projections as infill is based on a current local urbanization index.

18. The locally adaptive spatial system of claim 15 where the classifying of the population projections as sprawl is based on a current local urbanization index.

19. The locally adaptive spatial system of claim 15 where the potential growth surface comprise a surface represented by a plurality of cells each cell assigned individual cell weights.

20. A method for rendering spatially explicit population projections using a computer, the method comprising:
identifying selected land areas that are excluded from a future development;
identifying potential growth surfaces that identify second land areas that are projected to gain populations by modeling land variables;
classifying the population projections as infill or sprawl based on the current local urbanization index;
identifying potential loss surfaces that identify third land areas that are projected to lose populations; and
spatially allocating the population changes at a county level based on the infill, sprawl, and population loss designations.

21. The method of claim 20 further comprising generating rendering a cohort-component model that projects population changes at the county level.
